(19) United States
(12) Patent Application Publication
(10) Pub. No.: US 2017/0114572 A1
(43) Pub. Date: Apr. 27, 2017

(54) HELMET LOCK

(71) Applicant: Ronald F. Reda, Orland Park, IL (US)

(72) Inventor: Ronald F. Reda, Orland Park, IL (US)

(21) Appl. No.: 15/221,194

(22) Filed: Jul. 27, 2016

Related U.S. Application Data
(60) Provisional application No. 62/282,178, filed on Jul. 28, 2015.

(51) Int. Cl. E05B 73/00; A42B 3/04

(52) U.S. Cl. CPC E05B 73/0005; A42B 3/0413

(57) ABSTRACT

A helmet locking system for motorcycles utilizing a 3 piece arrangement of 2 balls and a length of cable. One ball being permanently mounted to the cable and the other ball being detachable. Said system does not require keys or a combination. Detachable ball is removed from its detachable member on the cable and is threaded through the D-ring or other open metal parts or nylon straps of a helmet. Detachable ball is then re-attached to the detachable member on the cable. Detachable ball is then laid into an open compartment that is about a motorcycle that has a locking lid or seat. Helmet and permanently mounted ball is now on the outside of the compartment or seat. The permanently mounted ball is too large to be pulled through the D-ring, open metal parts or nylon straps of the helmet, therefore the helmet is securely attached to the cable. Lid or seat is now closed and locked; the cable is now sandwiched in between the gap between the lid or seat and base of the compartment. Detachable ball is now “trapped” and “locked” on the inside of the compartment and is to big to be pulled back through the gap.

This application claims priority to provisional patent application No. 62/282,178 filed Jul. 28, 2015

### TECHNICAL FIELD

This invention relates to the field of locking and attaching your motorcycle helmet to your motorcycle

### BACKGROUND OF THE INVENTION

Currently in order to lock your helmet to your motorcycle you need a lock with a key or a combination lock, in some cases you need a cable or chain. These devices all need to attach to a part of the motorcycle where they can wrap the cable or chain around the frame or something that is part of the motorcycle. These devices are cumbersome and take up lots of storage space. Other more expensive devices hard mount to the motorcycle's frame or handlebars. These devices all require keys or combinations and are mounted with bolts and screws and are not meant to take on and off.

The present invention is provided to solve the problems discussed above and other problems, and to provide advantages and aspects not provided by prior motorcycle helmet locking devices of this type. A full discussion of the features and advantages of the present invention is deferred to the following detailed description, which proceeds with reference to the accompanying drawings.

### SPECIFICATION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. The present invention solves all the problems of the prior methods by not requiring any keys, combination or the need to wrap around the motorcycle parts. Said device comprises two balls attached on opposite ends of a cable or other rope like/type material. One ball is permanently mounted to cable and cannot be removed. The other ball can be released from the cable and re-attached. Upon releasing one ball from the cable you can now pull the cable through the D-ring or other open metal parts or nylon straps of a helmet. The permanently mounted ball is larger than the opening of the D-ring or other open metal parts or nylon straps of the helmet, this larger ball cannot be pulled through these openings. Once the cable has been threaded through the D-ring or other open metal parts or nylon straps of the helmet the detachable ball is now re-attached to the cable. On most motorcycles there is locking saddlebags, tour packs, trunks, locking seats and other locking compartments with lids about the motorcycle. The detachable ball is now laid “inside” one of these compartments. The helmet and permanent attached ball are now on the “outside” of the compartment, when the lid is closed and locked the detachable ball is now “trapped” and “locked” inside the compartment as the cable conforms to the profile of the overlapping lid and base and is “sandwiched” in between the two. With the lid now locked the ball trapped inside is too large to be pulled back through this much smaller gap. The helmet is now hanging on the outside of the compartment and is safe and secure from theft.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which;

FIG. 1 is a perspective view of the present invention showing the first member ball and second member ball in a connected view.

FIG. 2 is a perspective view of the present invention showing the first member ball and second member ball in a disconnected view

FIG. 3 is a perspective view of the present invention showing the cable being treaded through the D-Ring of the helmet.

FIG. 4 is a perspective view of the present invention showing the invention in it's state of use. The detachable ball is trapped inside the compartment while the permanently mounted ball is holding and securing the helmet,

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

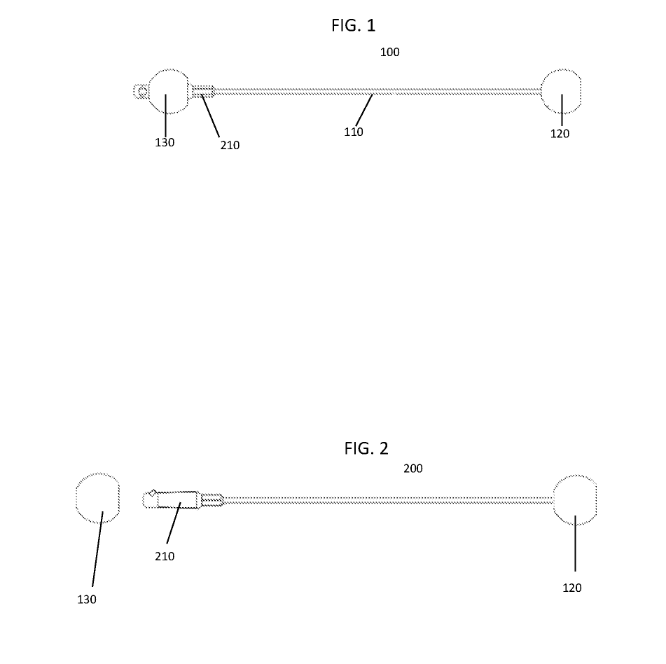

As illustrated in FIG. 1, in accordance with one or more embodiments of the present invention shows the helmet lock with the first member detachable ball 130 attached to the detachable member 210, which is permanently attached to the cable 110. The second member permanently attached ball 120 is attached to cable 110

As illustrated in FIG. 2, in accordance with one or more embodiments of the present invention shows the helmet lock with the first member detachable ball 130 detached from the detachable member 210, which is permanently attached to the cable 110. The second member permanently attached ball 120 is attached to cable 110

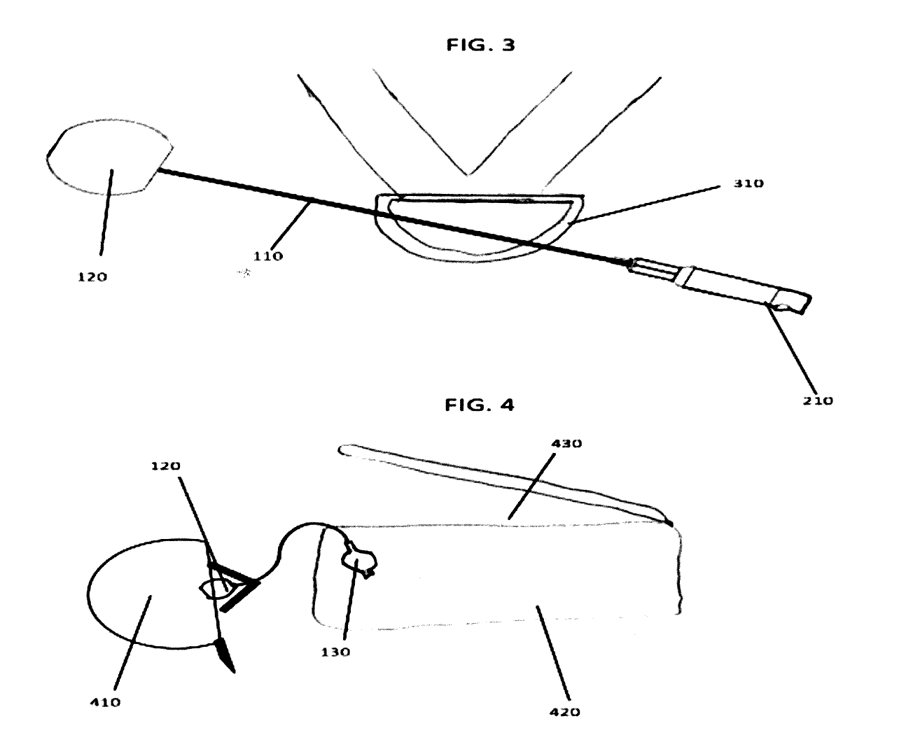

As illustrated in FIG. 3, in accordance with one or more embodiments of the present invention shows the helmet lock with the cable 110 and detachable member 210 being threaded through the helmet D-Ring 310.

As illustrated in FIG. 4, in accordance with one or more embodiments of the present invention shows the helmet lock being put into use. The detachable ball 130 is trapped inside the compartment 420 while the permanently mounted ball 120 is holding and securing the helmet 410. The lid 430 is locked down and sandwiching the cable 110.

While the specific embodiments have been illustrated and described, numerous modifications come to mind without significantly departing from the spirit of the invention and the scope of protection is only limited by the scope of the accompanying Claims.

What is claimed is:

1. A two piece helmet locking system comprising:
a first member structural ball having a permanently mounted length of cable attached to it on one end and a permanently attached disconnect member on the opposite end
a second member disconnecting ball that can be attached or detached to the disconnecting member at the opposite end of the cable from the permanently mounted ball.
